(19) United States
(12) Patent Application Publication
(10) Pub. No.: US 2008/0220123 A1
(43) Pub. Date: Sep. 11, 2008

(54) Process for Producing Cheese

(75) Inventors: Tine Muxoll Fatum, Alleroed (DK); Erik Hoeier, Valby (DK); John Lyne, North Logan, UT (US); Mikkel Laust Broe, Vanloese (DK)

Correspondence Address: NOVOZYMES NORTH AMERICA, INC., 500 FIFTH AVENUE, SUITE 1600, NEW YORK, NY, 10110, US

(73) Assignees: Novozymes A/S, Bagsvaerd (DK); Christian Hansen A/S, Hoersholm (DK)

(21) Appl. No.: 12/089,226

(22) PCT Filed: Oct. 13, 2006
(86) PCT No.: PCT/US2006/040402

§ 371 Date: May 6, 2008

(30) Foreign Application Priority Data
Oct. 17, 2005 (DK) PA 2005 01453

(51) Int. Cl. A23C 19/00

(52) U.S. Cl. 426/35

(57) ABSTRACT

The present invention relates to a method for producing cheese comprising treating cheese milk, or a fraction of cheese milk, with a phospholipase and adding whey protein to the cheese milk.

### TECHNICAL FIELD

The present invention relates to a process for producing cheese from enzyme-treated cheese milk with addition of whey protein.

### BACKGROUND OF THE INVENTION

During traditional production of cheese the milk is coagulated by acidification and/or addition of rennet. After coagulation the milk is separated into curd and whey and the whey is drained away from the curd. The cheese is produced by further processing of the curd, whereas the whey is a by-product of the cheese making process. Casein constitutes the major part of the milk protein, about 85% in cow's milk, the rest of the protein being classified as whey protein. During cheese production the major part of the casein is kept in the cheese whereas the major part of the whey proteins is lost in the whey. Whey proteins may be recovered from the whey and are used for a number of purposes, e.g. as ingredients in food products. Whey protein may also be used as ingredient in cheese, e.g. by adding whey protein to cheese milk. In this way the yield of cheese is increased, but addition of whey protein may lead to an increased loss of fat in the whey during cheese making.

WO 00/54601 discloses a method for improving the stability of the fat phase of cheese, comprising the steps of a) treating the cheese milk with a phospholipase and b) producing cheese from the cheese milk.

### SUMMARY OF THE INVENTION

It has now surprisingly been found that when cheese milk is treated with a phospholipase and whey protein is added to cheese milk, the yield of cheese is increased more than what could be expected by the results of the individual treatments. Similarly, the fat loss in the whey is reduced more than what could be expected from the known effect of phopsholipase treatment of cheese milk.

The present invention thus relates to a method for producing cheese, comprising: a) treating cheese milk, or a fraction of cheese milk, with a phospholipase; b) adding whey protein to the cheese milk; and c) producing cheese from the cheese milk with added whey protein.

### DETAILED DISCLOSURE OF THE INVENTION

Production of Cheese:

In the present context, the term “cheese” refers to any kind of cheese and such as, e.g., natural cheese, cheese analogues and processed cheese. The cheese may be obtained by any suitable process known in the art, such as, e.g., by enzymatic coagulation of cheese milk with rennet, or by acidic coagulation of cheese milk with food grade acid or acid produced by lactic acid bacteria growth. In one embodiment, the cheese manufactured by the process of the invention is rennet-curd cheese. Rennet is commercially available, e.g. as Naturen® (animal rennet), Chy-max® (fermentation produced chymosin), Microlant® (Microbial coagulant produced by fermentation), all from Chr. Hansen A/S, Denmark). The cheese milk may be subjected to a conventional cheese-making process.

Processed cheese is preferably manufactured from natural cheese or cheese analogues by cooking and emulsifying the cheese, such as, with emulsifying salts (e.g. phosphates and citrate). The process may further include the addition of spices/condiments. The term “cheese analogues” refers to cheese-like products which contain fat (such as, e.g., milk fat (e.g., cream) as a part of the composition, and which further contain, as part of the composition, a non-milk constituents, such as, e.g., vegetable oil.

The cheeses produced by the process of the present invention comprise all varieties of cheese, such as, e.g. Campesino, Chester, Danbo, Drabant, Herregård, Manchego, Provolone, Saint Paulin, Soft cheese, Svecia, Taleggio, White cheese, including rennet-curd cheese produced by rennet-coagulation of the cheese curd; ripened cheeses such as Cheddar, Colby, Edam, Muenster, Gruyere, Emmenthal, Camembert, Parmesan and Romano; blue cheese, such as Danish blue cheese; fresh cheeses such as Mozzarella and Feta; acid coagulated cheeses such as cream cheese, Neufchatel, Quarg, Cottage Cheese and Queso Blanco; and pasta filata cheese. One embodiment relates to the production of pizza cheese by the process of the invention.

In cheese manufacture, the coagulation of cheese milk is preferably performed either by rennet or by acidification alone resulting in rennet-curd and acid-curd cheese, respectively, making up two major groups of cheese types. Fresh acid-curd cheeses refer to those varieties of cheese produced by the coagulation of milk, cream or whey via acidification or a combination of acid and heat, and which are ready for consumption once the manufacturing without ripening is completed. Fresh acid-curd cheeses generally differ from rennet-curd cheese varieties (e.g. Camembert, Cheddar, Emmenthal) where coagulation normally is induced by the action of rennet at pH values 6.4-6.6, in that coagulation normally occurs close to the isoelectric point of casein, i.e. e.g. at pH 4.6 or at higher values when elevated temperatures are used, e.g. in Ricotta at pH typically about 6.0 and temperature typically about 80° C. In a preferred embodiment of the invention, the cheese belongs to the class of rennet curd cheeses.

Mozzarella is a member of the so-called pasta filata, or stretched curd, cheeses which are normally distinguished by a unique plasticizing and kneading treatment of the fresh curd in hot water, which imparts the finished cheese its characteristic fibrous structure and melting and stretching properties, cf. e.g. “Mozzarella and Pizza cheese” by Paul S. Kindstedt, Cheese: Chemistry, physics and microbiology, Volume 2: Major Cheese groups, second edition, page 337-341, Chapman & Hall. Pizza cheese as used herein includes cheeses suitable for pizzas and they are usually pasta filata/stretched curd cheeses. In one embodiment, the process of the invention further comprises a heat/stretching treatment as for pasta filata cheeses, such as for the manufacturing of Mozzarella.

Cheese Milk

Cheese milk according to the invention is the milk substrate from which the cheese is made. Milk may be the lacteal secretion of any mammal, e.g. cow, buffalo, sheep, goat, or camel. The fat content of the cheese milk may be adjusted to achieve the desired fat content of the cheese by any method known in the art. E.g. it is a common practice in cheese making to adjust the fat content of the milk used for cheese making to a desired ratio of protein to fat (P/F ratio), or more preferably to a desired ratio of casein to fat (C/F ratio). This may be done e.g. by separation of milk into cream and skim milk at arrival to the dairy. Thus, the cheese milk may be prepared as done conventionally by fractionating milk and recombining the fractions so as to obtain the desired final composition of the cheese milk. The separation may be made in continuous centrifuges leading to a skim milk fraction with very low fat content (i.e. e.g. <0.5%) and cream with e.g. >35% fat. The cheese milk may be prepared by mixing cream and skim milk. In another embodiment the protein and/or casein content is standardised by the use of Ultra Filtration.

In further embodiments of the invention, the cheese milk is prepared, totally or in part, from dried milk fractions, such as, e.g., whole milk powder, skim milk powder, casein, caseinate, total milk protein or buttermilk powder, or any combination thereof.

In one embodiment of the invention calcium is added to the cheese milk. Calcium may be added to the cheese milk at any appropriate step before and/or during cheese making, such as before, simultaneously with, or after addition of starter culture. Calcium may be added in any suitable form. In a preferred embodiment calcium is added as calcium salt, e.g. as CaCl₂. Any suitable amount of calcium may be added to the cheese milk. The concentration of added calcium will usually be in the range 0.1-5 mM, such as between 1 and 3 mM. If CaCl₂ is added to the cheese milk the amount will usually be in the range 1-50 g pr 100 l of cheese milk, such as in the range 5-30 g pr 100 l cheese milk, preferably in the range 10-20 g pr 100 l cheese milk.

Conventional steps may be taken to secure low bacterial counts in the cheese milk, such as pasteurisation, microfiltration or bactofugation. In one embodiment of the invention the cheese milk is raw, unpasteurised milk.

In one embodiment of the invention, the cheese milk may be subjected to a homogenization process before the production of cheese, such as e.g. in the production of Danish Blue Cheese.

The Enzymatic Treatment:

The enzymatic treatment in the process of the invention may e.g. be conducted by dispersing the phospholipase into the cheese milk, or the fraction of the cheese milk to be treated, and allowing the enzyme reaction to take place at an appropriate holding-time at an appropriate temperature. The treatment with phospholipase may be carried out at conditions chosen to suit the selected enzyme(s) according to principles well known in the art.

The enzymatic treatment may be conducted at any suitable pH, such as e.g., in the range 2-10, such as, at a pH of 4-9 or 5-7.

In one embodiment the phospholipase treatment is conducted at 3-60° C., such as at 25-45° C. (e.g., for at least 5 minutes, such as, e.g., for at least 10 minutes or at least 30 minutes, e.g., for 5-60 minutes).

The amount of phospholipase to be used in the method of the invention may depend on the activity of the specific phospholipase on milk phospholipids under the specific treatment conditions. The amount of phospholipase may be determined by the skilled person by methods known in the art for optimising enzymatic reactions, e.g. by determining the amount of phospholipase required to achieve the desired degree of hydrolysis of milk phospholipids.

The phospholipase is added in a suitable amount to produce the cheese having the desired properties. Preferably, the phospholipase is added in an amount effective to increase cheese yield. A suitable dosage of phospholipase may e.g. be in the range 0.003-0.7 mg enzyme protein per g milk fat, such as in the range 0.01-0.3 mg enzyme protein per g milk fat, or in the range, 0.03-0.1 mg enzyme protein per g milk fat.

When a phospholipase A is used the amount of phospholipase may e.g. be between 0.5 and 50 LEU (Lecitase Units) per gram of milk fat, such as between 1 and 25, or between 2 and 15 LEU per gram of milk fat.

In one embodiment of the invention a fraction of the cheese milk is treated with phospholipase. A fraction of the cheese milk may e.g. be cream or skim milk or mixtures of cream and skim milk in any appropriate ratio. In one embodiment of the invention milk is separated into cream and skim milk, and cream is treated with phospholipase. The treated cream may be mixed with skim milk to achieve a desired fat content of the cheese milk.

The treatment of cheese milk, or a fraction of cheese milk, with phospholipase may be conducted before, during or after whey protein is added to the cheese milk.

Addition of Whey Protein

Whey protein may be added in any appropriate form to the cheese milk, e.g. as a dry product, e.g. as Whey Protein Concentrate (WPC) or Whey Protein Isolate (WPI). A dried whey protein product may be suspended, e.g. in water, whey or milk, before addition to the cheese milk. Whey protein may also be added as a concentrated solution of whey protein, e.g. produced by concentration of whey, e.g. by ultrafiltration and/or evaporation.

If whey protein is added as a solution or suspension the concentration of whey protein in the solution or suspension may e.g. be in the range 2-30% (weight/weight), such as e.g. 3-20%, or 4-15%. A whey protein solution or suspension may be heat treated before addition to the cheese milk, it may e.g. be desirable to heat treat the suspension or solution so that all or some of the whey protein is denatured and/or aggregated. In one embodiment of the invention a whey protein solution or suspension is heat treated at 70-95° C. for 5-120 minutes before addition to the cheese milk. In another embodiment a whey protein suspension or solution is heat treated at a temperature and for a time sufficient to denature at least 25% of the whey protein, such as at least 40%, at least 60%, or at least 80% of the whey protein. When whey proteins are denatured by heat treatment they may aggregate and form aggregated particles of denatured whey protein. The size of such particles may be controlled by shearing the whey protein solution during the heat treatment. The amount of denatured whey protein may be determined by methods known in the art, e.g. by reversed-phase HPLC as described by Parris and Baginski, Journal of Dairy Science (1991), 74:58-64.

A whey protein solution or suspension to be added to the cheese milk may contain additional components, e.g. milk components, such as e.g. calcium phosphate, other salts and minerals originating from milk, lactose, milk fat, and/or casein.

A whey protein solution or suspension to be added to the cheese milk may contain starter culture and/or it may be fermented with starter microorganisms. Microorganism used in starter cultures or for fermentation of a whey protein solution or suspension may be any micro organisms known in the art for use in cheese production, either as starter culture or as adjunct culture. Microorganisms may be added for fermentation and acid production and/or for their effect on aroma and flavour formation in the cheese.

The amount of added whey protein may be any suitable amount that will lead to the desired effect, e.g. an increased cheese yield, without leading to unacceptable side effect, e.g. unacceptable taste or texture. In one embodiment of the invention at least 0.05% whey protein (weight/weight) is added to the cheese milk, such as at least 0.1%, or at least 0.2% whey protein. In another embodiment between 0.05 and 10% (weight/weight) whey protein is added to the cheese milk, such as between 0.1 and 5%.

The method of the invention may lead to an increased cheese yield compared to a similar cheese making process wherein no phospholipase treatment and/or addition of whey protein is performed.

Enzymes to be Used in the Process of the Invention:

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases A₁ and A₂ (commonly referred to as phospholipase A) which hydrolyze one fatty acyl group (in the sn-1 and sn-2 position, respectively) to form lysophospholipid. Phospholipase B hydrolyzes the remaining fatty acyl group in lysophospholipid.

The enzyme used in the process of the present invention include a phospholipase, such as, phospholipase A₁, phospholipase A₂, phospholipase B, phospholipase C or a phospholipase D. In the process of the invention the phospholipase treatment may be provided by one or more phospholipase, such as two or more phospholipases, e.g. two phospholipases, including, without limitation, treatment with both type A and B; both type A₁ and A₂; both type A₁ and B; both type A₂ and B; or treatment with two or more different phospholipase of the same type. Included is also treatment with one type of phospholipase, such as A₁, A₂, B, C or D.

Phospholipase A₁ is defined according to standard enzyme EC-classification as EC 3.1.1.32.
Official Name: Phospholipase A₁.
Reaction catalyzed:
phosphatidylcholine+H(2)O<>
2-acylglycerophosphocholine+a fatty acid anion
Comment: has a much broader specificity than EC 3.1.1.4.

Phospholipase A₂ is defined according to standard enzyme EC-classification as EC 3.1.1.4
Official Name: phospholipase A₂.
Alternative Names:phosphatidylcholine 2-acylhydrolase.
lecithinase a; phosphatidase; or phosphatidolipase.
Reaction catalysed:
phosphatidylcholine+H(2)O<>
1-acylglycerophosphocholine+a fatty acid anion
Comment: also acts on phosphatidylethanolamine, choline plasmalogen and phosphatides, removing the fatty acid attached to the 2-position.

Phospholipase B is defined according to standard enzyme EC-classification as EC 3.1.1.5.
Official Name: lysophospholipase.
Alternative Names: lecithinase b; lysolecithinase;
phospholipase B; or PLB.
Reaction catalysed:
2-lysophosphatidylcholine+H(2)O<>glycerophosphocholine +a fatty acid anion

Phospholipase C is defined according to standard enzyme EC-classification as EC 3.1.4.3. Phospholipase C hydrolyses the phosphate bond on phosphatidylcholine and other glycerophospholipids, e.g. phosphatidylethanolamine, yielding diacylglycerol; this enzyme will also hydrolyse the phosphate bonds of sphingomyelin, cardiolipin, choline plasmalogen and ceramide phospholipids.
Reaction with phosphatidylcholine:
phosphatidylcholine+water<=>1,2-diacylglycerol+choline phosphate

Phospholipase D is defined according to standard enzyme EC-classification as EC 3.1.4.4. Phospholipase D hydrolyses the phosphate bonds of phospholipids and sphingomyelin to give the corresponding phosphatidic acid.
Reaction with phosphatidylcholine:
A phosphatidylcholine+water<=>choline+a phosphatidate

Phospholipase A

Phospholipase A activity may be provided by enzymes having other activities as well, such as e.g. a lipase with phospholipase A activity. The phospholipase A activity may e.g. be from a lipase with phospholipase side activity. In other embodiments of the invention phospholipase A enzyme activity is provided by an enzyme having essentially only phospholipase A activity and wherein the phospholipase A enzyme activity is not a side activity.

Phospholipase A may be of any origin, e.g. of animal origin (such as, e.g. mammalian), e.g. from pancreas (e.g. bovine or porcine pancreas), or snake venom or bee venom. Alternatively, phospholipase A may be of microbial origin, e.g. from filamentous fungi, yeast or bacteria, such as the genus or species Aspergillus, e.g. A. niger; Dictyostelium, e.g. D. discoideum; Mucor, e.g. M. javanicus, M. mucedo, M. subtilissimus; Neurospora, e.g. N. crassa; Rhizomucor, e.g. R. pusillus; Rhizopus, e.g. R. arrhizus, R. japonicus, R. stolonifer; Sclerotinia, e.g. S. libertiana; Trichophyton, e.g. T. rubrum; Whetzelinia, e.g. W. sclerotiorum; Bacillus, e.g. B. megaterium, B. subtilis; Citrobacter, e.g. C. freundii; Enterobacter, e.g. E. aerogenes, E. cloacae Edwardsiella, E. tarda; Erwinia, e.g. E. herbicola; Escherichia, e.g. E. coli; Klebsiella, e.g. K. pneumoniae; Proteus, e.g. P. vulgaris; Providencia, e.g. P. stuartii; Salmonella, e.g. S. typhimurium; Serratia, e.g. S. liquefasciens, S. marcescens; Shigella, e.g. S. flexneri; Streptomyces, e.g. S. violaceoruber; Yersinia, e.g. Y. enterocolitica. Thus, phospholipase A may be fungal, e.g. from the class Pyrenomycetes, such as the genus Fusarium, such as a strain of F. culmorum, F. heterosporum, F. solani, or a strain of F. oxysporum. Phospholipase A may also be from a filamentous fungus strain within the genus Aspergillus, such as a strain of Aspergillus awamori, Aspergillus foetidus, Aspergillus japonicus, Aspergillus niger or Aspergillus oryzae. A preferred phospholipase A is derived from a strain of Fusarium, particularly F. venenatum or F. oxysporum, e.g. from strain DSM 2672 as described in WO 98/26057, especially described in claim 36 and SEQ ID NO. 2 of WO 98/26057. Another preferred phospholipase A is PLA2 from Streptomyces, such as e.g. PLA2 from S. violaceoruber. In further embodiments, the phospholipase is a phospholipase as disclosed in WO 00/32758 (Novozymes A/S, Denmark).

The activity of a phospholipase type A may e.g. be expressed in Lecitase Units (LEU). Phospholipase activity in Lecitase Units is measured relative to a phospholipase standard using lecithin as a substrate. Phospholipase A catalyzes the hydrolysis of lecithin to lysolecithin and a free fatty acid. The liberated fatty acid is titrated with 0.1 N sodium hydroxide under standard conditions (pH 8.00; 40.00° C.±0.5). The activity of phospholipase A is determined as the rate of sodium hydroxide consumption during neutralization of the fatty acid and is expressed in Lecitase units (LEU) relative to a Lecitase (phospholipase) standard (available from Novozymes A/S, Bagsværd, Denmark). 1 LEU is defined as the amount of enzyme that under standard conditions (pH 8.00; 40.00° C.±0.5) results in the same rate of sodium hydroxide consumption (μmol/min) as the Lecitase standard diluted to a nominal activity of 1 LEU/g.

Phospholipase B

The term “phospholipase B” used herein in connection with an enzyme of the invention is intended to cover an enzyme with phopholipase B activity.

The phospholipase B activity may be provided by enzymes having other activities as well, such as e.g. a lipase with phospholipase B activity. The phospholipase B activity may e.g. be from a lipase with phospholipase B side activity. In other embodiments of the invention the phospholipase B enzyme activity is provided by an enzyme having essentially only phospholipase B activity and wherein the phospholipase B enzyme activity is not a side activity. In one embodiment of the invention, the phospholipase B is not lipases having phospholipase B side activity as defined in WO 98/26057.

The phospholipase B may be of any origin, e.g. of animal origin (such as, e.g. mammalian), e.g. from liver (e.g. rat liver). Alternatively, the phospholipase B may be of microbial origin, e.g. from filamentous fungi, yeasts or bacteria, such as the genus or species Aspergillus, e.g. A. foetidus, A. fumigatus, A. nidulans, A. niger, A. oryzae; Botrytis, e.g. B. cinerea; Candida, e.g. C. albicans; Cryptococcus, e.g. C. neoformans, Escherichia, e.g. E. coli, Fusarium, e.g. F. sporotrichioides, F. venenatum, F. verticillioides; Hyphozyma; Kluyveromyces, e.g. K. lactis; Magnaporte, e.g. M. grisea; Metarhizium, e.g. M. anisopliae; Mycosphaerella, e.g. M. graminicola; Neurospora, e.g. N. crassa; Penicillium, e.g. P. notatum; Saccharomyces, e.g. S. cerevisiae; Schizosaccharomyces, e.g. S. pombe; Torulaspora, e.g. T. delbrueckii; Vibrio; e.g. V. cholerae. A preferred phospholipase B is derived from a strain of Aspergillus, particularly phospholipase LLPL-1 or LLPL-2 from A. niger, e.g. as contained in the Escherichia coli clones DSM 13003 or DSM 13004, or phospholipase LLPL-1 or LLPL-2 from A. oryzae, e.g. as contained in the E. coli clones DSM 13082 or DSM 13083 as described in WO 01/27251, especially described in claim 1 and SEQ ID NOs. 2, 4, 6 or 8 of WO 01/27251.

Phospholipase C

The phospholipase C activity may be provided by enzymes having other activities as well, such as e.g. a lipase with phospholipase C activity or a phosphatase with phospholipase C activity The phospholipase C activity may e.g. be from a lipase with phospholipase C side activity. In other embodiments of the invention the phospholipase C enzyme activity is provided by an enzyme having essentially only phospholipase C activity and wherein the phospholipase C enzyme activity is not a side activity.

The phospholipase C may be of any origin, e.g. of animal origin, such as mammalian origin, of plant origin, or of microbial origin, such as fungal origin or bacterial origin, such as from a strain of Mycobacterium, e.g. M. tuberculosis or M. bovis; a strain of Bacillus, e.g. B. cereus; a strain of Clostridium, e.g. C. bifermentans, C. haemolyticum, C. novyi, C. sordellii, or C. perfringens; a strain of Listeria, e.g. L. monocytogenes; a strain of Pseudomonas, e.g. P. aeruginosa; or a strain of Staphylococcus, e.g. S. aureus; or a strain of Burkholderia, e.g. B. pseudomallei.

Phospholipase D

The phospholipase D activity may be provided by enzymes having other activities as well, such as e.g. a lipase with phospholipase D activity, a phosphatase with phospholipase D activity, or a cholinesterase with phospholipase D activity. The phospholipase D activity may e.g. be from a lipase with phospholipase D side activity. In other embodiments of the invention the phospholipase D enzyme activity is provided by an enzyme having essentially only phospholipase D activity and wherein the phospholipase D enzyme activity is not a side activity.

The phospholipase D may be of any origin, e.g. of animal origin, such as mammalian origin, e.g. from mouse, rat, or Chinese hamster; of plant origin, e.g. from cabbage, maize, rice, castor bean, tobacco, cowpea, or Arabidopsis thaliana; or of microbial origin, such as of bacterial origin, e.g. from a strain of Corynebacterium, e.g. C. pseudotuberculosis, C. ulcerans, or C. haemolyticum; or fungal origin, such as e.g. from a strain of Streptomyces, e.g. S. antibioticus or S. chromofuscus; a strain of Trichoderma, e.g. T. reesei; a strain of Saccharomyces, e.g. S. cerevisiae; or a strain of Aspergillus, e.g. A. oryzae, A. niger, A. nidulans or A. fumigatus.

Enzyme Sources and Formulation

The phospholipase used in the process of the invention may be derived or obtainable from any of the sources mentioned herein. The term “derived” means in this context that the enzyme may have been isolated from an organism where it is present natively, i.e. the identity of the amino acid sequence of the enzyme are identical to a native enzyme. The term “derived” also means that the enzymes may have been produced recombinantly in a host organism, the recombinant produced enzyme, having either an identity identical to a native enzyme or having a modified amino acid sequence, e.g. having one or more amino acids which are deleted, inserted and/or substituted, i.e. a recombinantly produced enzyme which is a mutant and/or a fragment of a native amino acid sequence. Within the meaning of a native enzyme are included natural variants. Furthermore, the term “derived” includes enzymes produced synthetically by e.g. peptide synthesis. The term “derived” also encompasses enzymes which have been modified e.g. by glycosylation, phosphorylation etc., whether in vivo or in vitro. The term “obtainable” in this context means that the enzyme has an amino acid sequence identical to a native enzyme. The term encompasses an enzyme that has been isolated from an organism where it is present natively, or one in which it has been expressed recombinantly in the same type of organism or another, or enzymes produced synthetically by e.g. peptide synthesis. With respect to recombinantly produced enzyme the terms “obtainable” and “derived” refers to the identity of the enzyme and not the identity of the host organism in which it is produced recombinantly.

Accordingly, the phospholipase may be obtained from a microorganism by use of any suitable technique. For instance, a phospholipase enzyme preparation may be obtained by fermentation of a suitable microorganism and subsequent isolation of a phospholipase preparation from the resulting fermented broth or microorganism by methods known in the art. The phospholipase may also be obtained by use of recombinant DNA techniques. Such method normally comprises cultivation of a host cell transformed with a recombinant DNA vector comprising a DNA sequence encoding the phospholipase in question and the DNA sequence being operationally linked with an appropriate expression signal such that it is capable of expressing the phospholipase in a culture medium under conditions permitting the expression of the enzyme and recovering the enzyme from the culture. The DNA sequence may also be incorporated into the genome of the host cell. The DNA sequence may be of genomic, cDNA or synthetic origin or any combinations of these, and may be isolated or synthesized in accordance with methods known in the art.

Suitable phospholipases are available commercially. As typical examples of the enzymes for practical use, pancreas-derived phospholipase A₂ such as Lecitase® (manufactured by Novozymes A/S, Bagsværd, Denmark) is preferably used. A suitable phospholipase B is e.g. Aspergillus niger phospholipase LLPL-2 that can be produced recombinantly in A. niger as described in WO 01/27251.

In the process of the invention the phospholipase may be purified. The term “purified” as used herein covers phospholipase enzyme protein free from components from the organism from which it is derived. The term “purified” also covers phospholipase enzyme protein free from components from the native organism from which it is obtained, this is also termed “essentially pure” phospholipase and may be particularly relevant for phospholipases which are naturally occurring and which have not been modified genetically, such as by deletion, substitution or insertion of one or more amino acid residues.

Accordingly, the phospholipase may be purified, viz. only minor amounts of other proteins being present. The expression “other proteins” relate in particular to other enzymes. The term “purified” as used herein also refers to removal of other components, particularly other proteins and most particularly other enzymes present in the cell of origin of the phospholipase. The phospholipase may be “substantially pure”, i.e. free from other components from the organism in which it is produced, i.e., e.g., a host organism for recombinantly produced phospholipase. Preferably, the enzymes are at least 75% (W/W) pure, more preferably at least 80%, 85%, 90% or even at least 95% pure. In a still more preferred embodiment the phospholipase is an at least 98% pure enzyme protein preparation. In other embodiments the phospholipase is not naturally present in milk.

The terms “phospholipase” includes whatever auxiliary compounds that may be necessary for the catalytic activity of the enzyme, such as, e.g. an appropriate acceptor or cofactor, which may or may not be naturally present in the reaction system.

The phospholipase may be in any form suited for the use in question, such as e.g. in the form of a dry powder or granulate, a non-dusting granulate, a liquid, a stabilized liquid, or a protected enzyme. Granulates may be produced, e.g. as disclosed in U.S. Pat. No. 4,106,991 and U.S. Pat. No. 4,661,452, and may optionally be coated by methods known in the art. Liquid enzyme preparations may, for instance, be stabilized by adding stabilizers such as a sugar, a sugar alcohol or another polyol, lactic acid or another organic acid according to established methods. Protected enzymes may be prepared according to the method disclosed in EP 238,216.

By the process of the invention, the lecithin content of the cheese may be reduced by at least 5%, such as at least 10%, at least 20%, at least 30%, at least 50%, such as in the range of 5-95% compared to a similar cheese making process but without the enzymatic treatment of a phospholipase, as described herein.

In cow milk, the lecithin constitutes normally more than 95% of the phospholipids in milk whereas the lysolecithin is approximately 1% of the phospholipids. Although the phospholipids represent normally less than 1% of the total lipids in cow milk, they play a particularly important role, being present mainly in the milk fat globule membrane. By the process of the present invention the lecithin content in the obtainable cheese may be less than 90%, such as e.g. less than 80%, e.g. less than 60% or less than 50% of the total content of phospholipid in the cheese. The lecithin content may be measured by any method known by the skilled person, e.g. by HPLC.

After treatment with phospholipase the cheese milk may be subjected to a heat treatment. In one embodiment the heat treatment is conducted at a time-temperature combination sufficient to inactivate the enzyme.

The present invention further relates to use of the cheese produced by the process of the invention in pizza, ready-to-eat dishes, processed cheese, or as an ingredient in other food products. Accordingly, the cheese produced according to the process of the invention may be used in further processed food products like processed cheese, pizza, burgers, toast, sauces, dressings, cheese powder or cheese flavours.

In further embodiments, the process of the invention further comprises the step of subjecting the cheese to a heating treatment, such as, e.g., in the range 150-350° C.

The present invention is further illustrated in the following examples which are not to be in any way limiting to the scope of protection.

### EXAMPLE 1

### Production of Pizza Cheese without Whey Protein Addition

Materials:

Cheese milk: Pasteurised cow's milk standardised with cream with 38% fat to the desired fat content required for production of Pizza cheese with 40% fat in dry matter.

Phospholipase: Phospholipase A1 derived from Fusarium venenatum (YieldMAX® PL, Novozymes A/S and Chr. Hansen A/S, Denmark).

Cheese Manufacture

Standardised milk at 34.5° C. was inoculated with 0.01% F-DVS St-M5 culture from Chr. Hansen A/S, Hørsholm, Denmark and pre-ripened for 60 min. Phospholipase with strength of 200 LEU per ml was added to the cheese milk 20 minutes before rennet addition with an amount of 5 LEU per g of milk fat. Control cheese were produced without addition of phospholipase. The milk was coagulated with rennet (33.75 g per 150 l milk of Chy-Max Plus (200 IMCU) from Chr. Hansen A/S, Hørsholm, Denmark) at 34.5° C. until the curd was judged ready for cutting and cut with 10 mm wire frames in all 3 directions. The coagulum was stirred in the whey at 380 rph and after 10 minutes the scalding was started by increasing the temperature steadily for 30 minutes to 41° C. and the curd was stirred for 20 minutes at this temperature until pH was 6.2. The curd was then allowed to settle in the vat and the whey was drained. After 10 minutes the curd was cut into uniform blocks which were kept in stacks of two and turned every 10 minutes. When pH had reached 5.15-5.20 the curd was milled and 2% NaCl (weight/weight) was mixed into the curd and the curd/NaCI mixture was mixed frequently over the next 5-10 minutes. The curd was then added into a stretcher containing preheated water at 74° C. The stretching was stopped after 6 minutes when the curd temperature had reached 62° C. The curd was moved to an extruder with a chamber temperature of 62° C. and the curd was extruded into loafs of around 2.5 kg with an outlet temperature of 58° C. The cheese loafs where cooled in 5-7° C. water for 20 minutes and brined in saturated brine at 5-6° C. for 90 minutes. After brining the cheeses were dried, weighed and vacuum packed.

Experimental Design and Statistical Analysis

During each day of cheese making 4 vats of 150 kg of milk were produced from the same lot of milk with two controls (without enzyme) and two experimental vats per day. Cheese making was replicated on five different days for a total of 20 cheese vats. The treatments were randomized according to a Latin square, where the treatments were balanced according to day and vat. Statistical evaluation was made using multiple linear correlation analysis.

Sampling of Cheese

Two out of the six cheeses made from each vat were randomly chosen for analysis. The chosen cheeses were cut into eight parts with the same surface area. Each part was grated separately and analysed. The compositional results of cheese from each vat were calculated as the average composition of the two sampled cheeses, duplicate analysis was done on each cheese.

Analysis:

The composition of protein, fat, salt and moisture was determined after 1 week using a FoodScan Dairy Analyser (FOSS Analytical A/S, Hilleroed, Denmark). Content of fat, lactose, protein, and SNF (solids not fat) in milk, whey and stretch water was measured using a MilkoScan (FOSS Analytical A/S, Hilleroed, Denmark). Samples of stretch water were additionally sent to Steins Laboratorium to evaluate MilkoScan determinations of fat. The percent of fat, protein and SNF retained in the cheeses were calculated from these data according to the milk-in, whey- and cheese-out mass balance. In order to compensate for variations in moisture in the cheeses, the yield calculation was adjusted for moisture differences with an index of 48% moisture (adjusted yield). Differences observed (increase or decrease) as an effect of phospholipase treatment were calculated as percentages of the average of control vats.

Results

Table 1 shows compositional results for whey, stretchwater and cheese.

TABLE 1

| | | | | 95% Confidence | |
|---|---|---|---|---|---|
| | | | | intervals | |
| | | | Effect in % | for effect | |
| | Control | Treated | of control | % of control | |
| | (average) | (average) | avg. | avg. | P-value |
| Fat in whey (%) | 0.13 | 0.13 | −3.0 | [−7.5 to 1.5%] | Not sign. |
| Fat in stretch water | 0.14 | 0.11 | −21.0 | [−29.1 to −12.9%] | <0.001 |
| (%) | | | | | |
| Moisture in cheese | 47.0 | 47.8 | 1.6 | [1.0 to 2.3%] | <0.001 |
| (%) | | | | | |
| Fat in dry matter | 41.6 | 41.8 | 0.6 | [0.3 to 0.9%] | <0.05 |
| (%) | | | | | |
| MNFS (%) | 60.3 | 61.1 | 1.4 | [0.9 to 1.8%] | <0.001 |
| Protein retention | 76.7 | 76.9 | 0.5 | [−0.4 to 1.3%] | Not sign. |
| (%) | | | | | |
| Fat retention (%) | 87.5 | 89.3 | 2.1 | [1.4 to 2.8%] | <0.001 |

Table 2 shows results for cheese yield

TABLE 2

| | | | | 95% | |
|---|---|---|---|---|---|
| | | | | Confidence | |
| | | | Effect | intervals | |
| | | | in % | of effect | |
| | Control | Treated | of control | % of control | |
| | (average) | (average) | avg. | avg. | P-value |
| Weight of | 15.7 | 16.0 | 2.7 | [1.7 to 3.6%] | <0.001 |
| cheese | | | | | |
| Actual yield | 10.4 | 10.7 | 2.7 | [2.1 to 3.3%] | <0.001 |
| Adj. yield | 10.6 | 10.7 | 1.2 | [0.7 to 1.7%] | <0.001 |

### EXAMPLE 2

### Production of Pizza Cheese with Whey Protein Addition

Pizza cheese was made after the same procedure as in example 1, except that a whey protein solution was added to the milk when filling the cheese vat.

Whey protein was added as a solution of Whey Protein Concentrate (Ultralac 35, Arla Foods Ingredients, Denmark) with 20% dry matter and approximately 7% protein, which was heat treated at 80-85° C. for 45 minutes before addition. 3% of the cheese milk was substituted with the WPC solution.

Results

Table 3 shows compositional results for whey, stretchwater and cheese.

TABLE 3

| | | | | 95% Confidence | |
|---|---|---|---|---|---|
| | | | Effect | intervals | |
| | | | in % | of effect | |
| | Control | Treated | of control | % of control | |
| Production variables | (average) | (average) | avg. | avg. | P-value |
| Fat in whey (%) | 0.14 | 0.13 | −8.2 | [−19.1 to 2.7%] | Not sign. |
| Fat in stretch | 0.39 | 0.34 | −12.5 | [−22.5 to −2.5%] | <0.05 |
| water (%) | | | | | |
| Moisture in | 51.8 | 52.6 | 1.6 | [−1.4 to 4.6%] | Not sign. |
| cheese (%) | | | | | |
| Fat in dry matter | 39.1 | 39.5 | 0.9 | [−0.2 to 2.1%] | Not sign. |
| (%) | | | | | |
| MNFS (%) | 63.9 | 64.7 | 1.4 | [−0.9 to 3.7%] | Not sign. |
| Protein retention | 74.2 | 74.7 | 0.6 | [−0.3 to 1.5%] | Not sign. |
| (%) | | | | | |
| Fat retention | 82.3 | 85.5 | 3.9 | [2.0 to 5.8%] | <0.01 |
| (%) | | | | | |

Table 4 shows results for cheese yield.

TABLE 4

| | | | | 95% | |
|---|---|---|---|---|---|
| | | | | Confidence | |
| | | | Effect | intervals | |
| | | | in % | for effect | |
| | Control | Treated | of control | % of control | |
| | (average) | (average) | avg. | avg. | P-value |
| Weight of | 16.9 | 17.7 | 4.7 | [1.3 to 8.1%] | <0.05 |
| cheese | | | | | |
| Actual yield | 11.3 | 11.8 | 4.7 | [1.3 to 8.1%] | <0.05 |
| Adj. yield | 10.5 | 10.8 | 3.0 | [2.2 to 3.7%] | <0.001 |
| (48% | | | | | |
| moisture) | | | | | |

1-9. (canceled)

10. A method for producing cheese, comprising:
a) treating cheese milk or a fraction of cheese milk with a phospholipase;
b) adding whey protein to the cheese milk; and
c) producing cheese from the cheese milk with added whey protein.

11. The method of claim 10, wherein step a) is conducted before step b).

12. The method of claim 10, wherein step b) is conducted before step a).

13. The method of claim 10, wherein the amount of whey protein added during step b) is at least 0.05% (weight/weight) of the cheese milk.

14. The method of claim 10, wherein the amount of whey protein added during step b) is at least 0.1% (weight/weight) of the cheese milk.

15. The method of claim 10, wherein the amount of whey protein added during step b) is between 0.05% and 10% (weight/weight) of the cheese milk.

16. The method of claim 10, wherein the added whey protein is whey protein concentrate or whey protein isolate.

17. The method of claim 10, wherein the whey protein to be added to the cheese milk has been heat treated prior to the addition to the cheese milk at a temperature and time sufficient to denature at least 25% of the whey protein.

18. The method of claim 10, wherein the whey protein to be added to the cheese milk has been heat treated prior to the addition to the cheese milk at a temperature of at least 70° C. for at least 10 minutes.
